(19) United States
(12) Patent Application Publication
(10) Pub. No.: US 2025/0124366 A1
(43) Pub. Date: Apr. 17, 2025

(54) CLASSICAL HYBRID SOLUTION TO MULTI-STOP ROUTING

(71) Applicant: Unisys Corporation, Blue Bell, PA (US)

(72) Inventor: Dastgeer SHAIKH, Plainsboro Township, NJ (US)

(73) Assignee: Unisys Corporation, Blue Bell, PA (US)

(21) Appl. No.: 18/915,908

(22) Filed: Oct. 15, 2024

(30) Foreign Application Priority Data
Oct. 16, 2023 (IN) 202311070266

(51) Int. Cl. G06Q 10/047

(52) U.S. Cl. CPC G06Q 10/047

(57) ABSTRACT

Relational routing data tables are converted into graphs comprising nodes and vertices. The nodes can include origins and destinations associated with routes, while the vertices represent route parameters. Route segments can then be mapped from the graphs. For an origin-destination input, a set of shortest parameterized paths among the route segments is identified. These shortest parameterized paths includes route segments weighted over a range of route parameters. Within a solution domain, an optimal solution can be generated by filtering the shortest parameterized path based on a set of one or more selected parameters to generate an optimal solution. A classical threshold determines whether the optimal solution is generated using a classical computing process or a quantum computing process.

### CROSS-REFERENCE TO RELATED APPLICATIONS

This application claims the benefit of priority to Indian patent application Ser. No. 202311070266, filed in the Indian Patent Office on Oct. 16, 2023, and entitled “A CLASSICAL HYBRID SOLUTION TO MULTI-STOP ROUTING,” the contents of which are hereby incorporated by reference in their entirety.

### BACKGROUND

Logistics route optimization is a process in supply chain management, aiming to enhance efficiency by determining the most effective routes for transporting objects between various nodes (representing origins and destinations associated with routes). This process encompasses a multitude of variables and necessitates sophisticated algorithms to solve. A classic, well-studied problem in this domain is the Traveling Salesman Problem (TSP), which asks for the shortest possible route that visits each city exactly once and returns to the origin city. The TSP, though simple to state, is a computationally challenging problem, and its solutions have broad applications in logistics, aiding in the design of effective delivery and transportation systems, and the programs that govern these systems.

### SUMMARY

The present technology relates to a hybrid solver for determining an optimal route as a solution to a logistics optimization problem for moving objects between and through nodes. In an implementation of the technology, relational routing data tables are converted into graphs comprising nodes and vertices. The nodes can include origin and destination associated with routes, while the vertices represent one or more route parameters, such as distance, time, cost, weight, or volume. Route segments can then be mapped from the graphs.

An origin-destination input may be received from a computing device. For the origin-destination input, a shortest parameterized path among the route segments is identified. The shortest parameterized path includes route segments weighted over a range of route parameters, where the parameters are governed by a constraint equation corresponding to an objective function. A solution domain can be determined from the range of input parameters.

Within the solution domain, an optimal solution can be generated based on applying a classical threshold. The classical threshold can be used to determine whether the optimal solution is generated using a classical computing process or a quantum solution process. The classical computing process invokes a classical computing device to determine the optimal solution from the solution domain, while the quantum computing process invokes a quantum annealer to determine the optimal solution from the solution domain.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an operating environment in which aspects of the technology may be implemented, in accordance with an aspect described herein;

FIG. 2 illustrates an example hybrid solver process that can be implemented using components of FIG. 1, in accordance with an aspect described herein;

FIG. 3 illustrates a block diagram of an example method for determining an optimal routing solution, in accordance with an aspect described herein;

FIG. 4 illustrates an example quantum annealer suitable for use with the present technology, in accordance with an aspect described herein;

FIG. 5 illustrates an example quantum annealing process the may be performed by the quantum annealer of FIG. 4 to determine an optimal routing solution, in accordance with an aspect described herein; and

FIG. 6 illustrates an example computing device suitable for implementing aspects of the present technology, in accordance with an aspect described herein.

FIG. 7 illustrates a block diagram of an example method for determining an optimal routing solution, in accordance with an aspect described herein.

### DETAILED DESCRIPTION

Logistic optimization of routes is a complex problem both mathematically and computationally. It may be described as a combinatorial optimization problem with N-polynomial hard complexity and can have a large solution domain that is computationally highly intensive to access on a given modern-day computer, including the use of cloud computing resources and high performance computing (HPC). These logistics problems arise in a multitude of areas where objects can be moved within various locations along different defined routes, including transportation of cargo, such as freight or people, using ground routes, air routes, and combinations thereof; movement of objects about a facility, such as along conveyor systems or other transport systems; routing of aircraft, ground vessels, or sea vessels about various destinations; or other like routing processes moving object(s) to locations in which there are multiple travel paths through multiple nodes.

The complexity of the decision making when determining optimal routes exponentially increases with the number of routes, constraints, objective functions, and many other parameters that play pivotal roles in obtaining a meaningful solution. Attempts to solve these problems using quantum computing techniques rely on quadratic and binary optimizations. Even with these approaches, not all solutions can be determined and even good solutions may not be determined in a realistic timeframe.

An aspect of the technology employs a hybrid approach (i.e., a classical hybrid solver to identify efficient and feasible optimization solutions) that has two steps. In the first step, a classical optimization methodology is adapted to seek out optimal routing solutions. In the second step, parametric distillation of solution is applied, which is driven by input parameters and constraints to ensure a valid optimal solution is obtained. If the size of the solution domain can be explored classically, a classical computing device is invoked to solve the optimization problem. In contrast, if the size of the solution domain is too intensively complex (timewise, space-wise) to be treated classically, an alternative solver (e.g., a quantum computing device using quantum annealing) is invoked to handle the large size solution. The determination of whether to invoke a classical solver or a quantum solver is done during computation using a heuristic threshold that enables the separation of the classical and quantum boundaries of the solution space.

The present technology differs from that of existing solvers and departs from conventional processes. For example, most conventional solvers start from an entire math formulation encompassing all data elements mapped to objective functions, constraints, inequalities, parameters, etc., thereby making the solution domain highly sparse and computationally expensive. Unlike these solvers, the present technology is based on a hybrid approach in which a partial amount of data is transformed into graph nodes and is subsequently minimized classically to parametrized shortest path solutions. This step is followed by a data distillation method to capture the optimal solution.

Moreover, most conventional solvers have considerable overheads in terms of time and space requirements. For example, they take a longer time (e.g., several seconds to minutes) to pre-solve (i.e., data and model loading time) and return a response (i.e., solution time). Unlike these solvers, the classical hybrid solver can pre-solve and return a response within the order of a few milliseconds.

Further, the internal data representation of the data, as well as consumption of the data by the classical hybrid solver, departs from that of conventional methods. For instance, aspects of the hybrid solver technology use nested and deeply connected graph node data elements as compared to some conventional methods that utilize relational data elements.

The technology provided herein, may be used for route optimization, such as routes used for delivering cargo, including ground vehicle routes, sea vehicle routes, air vehicle routes, or any combinations thereof; general multi-stop route determination; movement of vehicles or objects about a facility, such as a storage facility, manufacturing facility, and the like; or other like object movement process where there are multiple path options for an object between any number of starting or destination points.

It will be realized that the method previously described is only an example that can be practiced from the description that follows, and it is provided to more easily understand the technology and recognize its benefits. Additional examples are now described with reference to the figures.

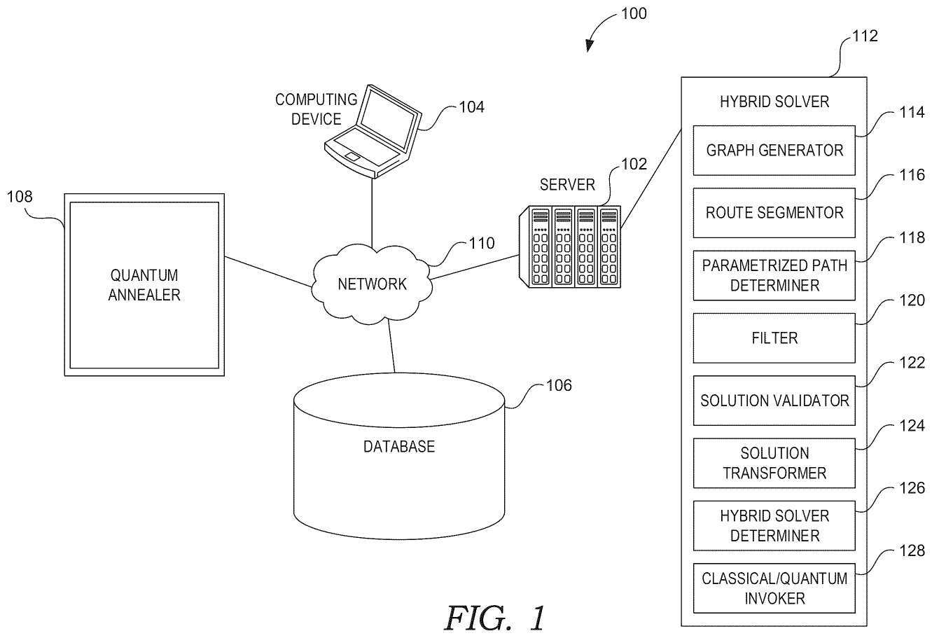

With reference now to FIG. 1, an example operating environment 100 in which aspects of the technology may be employed is provided. Among other components or engines not shown, operating environment 100 comprises server 102, computing device 104, database 106, and quantum annealer 108 which are communicating via network 110.

Database 106 generally stores information, including data, computer instructions (e.g., software program instructions, routines, or services), or models used in embodiments of the described technologies. Although depicted as a single database component, database 106 may be embodied as one or more databases or may be in the cloud. In aspects, database 106 is representative of a distributed ledger network.

Network 110 may include one or more networks (e.g., public network or virtual private network [VPN]), as shown with network 110. Network 110 may include, without limitation, one or more local area networks (LANs), wide area networks (WANs), or any other communication network or method.

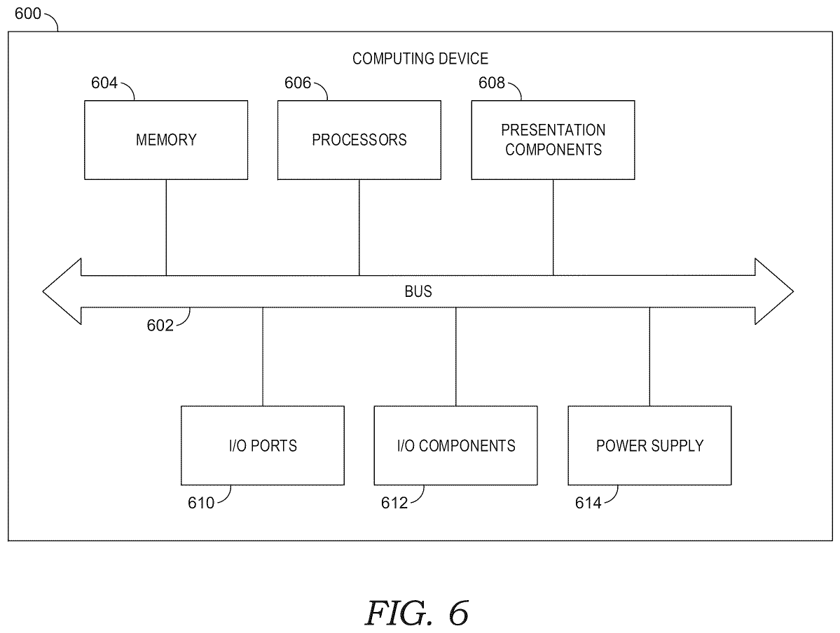

Generally, server 102 is a computing device that implements functional aspects of operating environment 100, such as one or more functions of hybrid solver 112 to facilitate determination of an optimal solution to a logistics optimization problem, such as determining an optimal route for objects traveling through a plurality of nodes (representing origins and destinations associated with routes). One suitable example of a computing device that can be employed as server 102 is described as computing device 1000 with respect to FIG. 6. In implementations, server 102 represents a back-end or server-side device.

Computing device 104 is generally a computing device that may be used to interface with server 102. As with other components of FIG. 1, computing device 104 is intended to represent one or more computing devices. One suitable example of a computing device that can be employed as computing device 104 is described as computing device 1000 with respect to FIG. 6. In implementations, computing device 104 is a client-side or front-end device.

While the example architecture illustrated in FIG. 1 illustrates functions of hybrid solver 112 being performed by server 102, it will be understood that this is just one example, and there may be more or fewer functions of hybrid solver 112, which may be employed in various orders. It is further noted that, in some implementations of the technology, functions of hybrid solver 112 may be performed by other components of FIG. 1, including components not shown. As an example, in some implementations, computing device 104 may be used to perform functions of hybrid solver 112 in lieu of or in combination with server 102. The illustrated drawing is but one example used to aid in describing an aspect of the technology.

Quantum annealer 108 generally comprises an analog quantum computing device, such as those suitable for performing quantum annealing. As will be further described, quantum annealer 108 may receive instructions from other components of FIG. 1 for solving a quantum problem, such as an optimization problem. Quantum annealer 108 may be configured to determine or receive a quantum problem and find an optimal or near-optimal solution to the problem through an annealing process, such as quantum annealing process 500. Quantum annealer 400 represents an example quantum annealer 400 that may be suitable as quantum annealer 108.

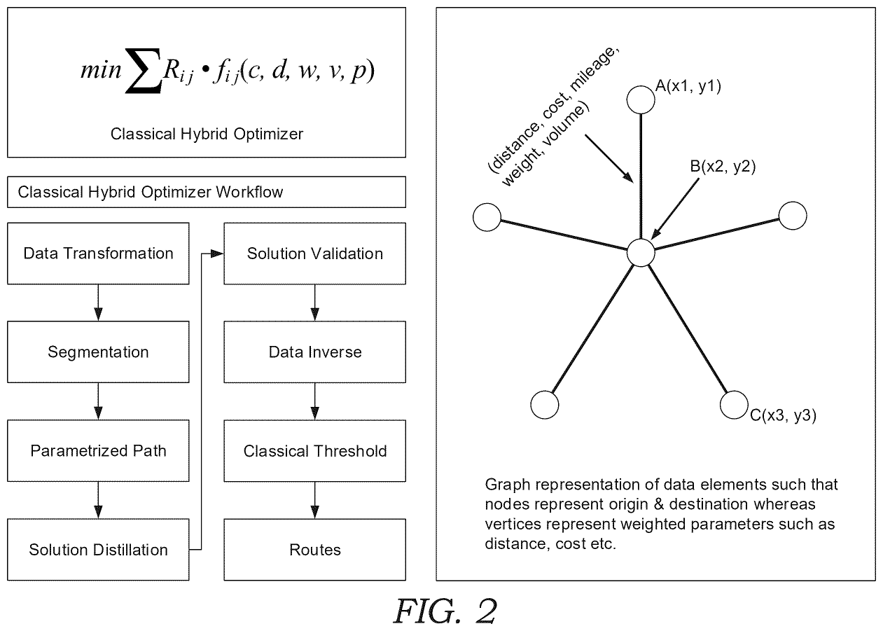

To determine a solution to an optimization problem, server 102 may employ hybrid solver 112. In the example illustrated, hybrid solver 112 comprises graph generator 114, route segmentor 116, parametrized path determiner 118, filter 120, solution validator 122, solution transformer 124, hybrid solver determiner 126, and classical/quantum invoker 128. Some example functions performed by these components are described with respect to FIG. 2, as will be further described.

In one example, graph generator 114 converts relational routing data tables into graphs includes nodes and vertices, where nodes include origins and destinations associated with routes, and where vertices represent one or more route parameters. As examples, the one or more route parameters may comprise at least one of distance, time, cost, weight, volume, or other like route parameter.

In this example, route segmentor 116 maps route segments from the graphs. In some aspects, route segmentor maps route segments based on applying filter 120. In aspects of the example, filter 120 may be used to filter the optimal routing solution from the range of input parameters such that the optimal routing solution respects solution constraints and the objective function. For example, filter 120 may be applied to reduce the route segments mapped by route segmentor 116 to flights departing at a particular location on a particular day by a particular time or arriving at a particular location on a particular day by a particular time. In this way the amount of data is filtered as the hybrid solver determiner 126 determines a solution domain from the range of input parameters.

In this example, classical/quantum invoker 128 determines an optimal solution within the solution domain by invoking one of a classical computing process or a quantum computing process based on applying a classical threshold. The classical computing process uses a classical computing device to determine the optimal solution from the solution domain, and the quantum computing process uses a quantum annealer to determine the optimal solution from the solution domain. In some aspects, the threshold may be based on a size of the initial data set (e.g., relational routing data tables). Additionally or alternatively, the threshold may be based on the time required to determine the optimal solution within the solution domain.

Once the classical threshold has been applied and the classical computing device or the quantum annealer is selected, the solution domain can be used by parametrized path determiner 118 to identify a shortest parameterized path among the route segments. For clarity, the shortest parameterized path includes route segments weighted over a range of route parameters governed by a constraint equation corresponding to an objective function. The shortest parameterized path can be identified for an origin-destination input identifying an origin of an object and destination for the object to be delivered.

In aspects of the example, solution transformer 124 performs inverse transforming on the optimal routing solution to map the optimal routing solution to the origin-destination input to output the optimal routing solution to a computing device. Initially, the optimal routing solution is returned as data in the form of nodes. Solution transformer 124 performs an inverse conversion of the graph data into a consumable output (i.e., human readable form) so any end user can read the data and readily understand the optimal routing solution. For example, the optimal routing solution may be returned in the following format:
best feasible solution is: {‘booking_0_0_0_1’: 0.0,‘booking_0_1_0_1’:0.0,
‘booking_0_1_1_2’:0.0, ‘booking_0_1_2_3’:0.0, ‘booking_0_2_0_3’:1.0,
‘booking_0_3_0_1’:0.0, ‘booking_0_3_1_2’:0.0, ‘booking_1_0_0_1’:0.0,
‘booking_1_1_0_1’:0.0, ‘booking_1_1_1_2’:0.0, ‘booking_1_1_2_3’:0.0,
‘booking_1_2_0_3’:0.0, ‘booking_1_3_0_1’:0.0, ‘booking_1_3_1_2’:0.0,
‘booking_2_0_0_1’:0.0, ‘booking_2_1_0_1’:0.0, ‘booking_2_1_1_2’:0.0,
‘booking_2_1_2_3’:0.0, ‘booking_2_2_0_3’:1.0, ‘booking_2_3_0_1’:0.0,
‘booking_2_3_1_2’:0.0, ‘booking_3_0_0_1’:0.0, ‘booking_3_1_0_1’:0.0,
‘booking_3_1_1_2’:0.0, ‘booking_3_1_2_3’:0.0, ‘booking_3_2_0_3’:0.0,
‘booking_3_3_0_1’:0.0, ‘booking_3_3_1_2’:0.0, ‘selected_0’: 1.0, ‘selected_1’: 1.0, ‘selected_2’:1.0, ‘selected_3’:1.0}

Solution transformer 124 converts the above graph data into segment information in human readable form. For example, as shown below, the output below suggests a shipper book a flight (e.g., UW226) for the shipment to achieve the objectives (e.g., maximum revenue and shortest distance):

{ {‘FLIGHT ID’: ‘UW226’,
‘DEP’: ‘DEL’,
‘ARR’: ‘BOM’,
‘DEPARTURE DATE TIME’: ‘2022-10-23 05:04:04’,
‘ARRIVAL DATE TIME’: ‘2022-10-21 19:01:53’,
‘FLIGHT DURATION’: 8617,
‘MILAGE’: 162,
‘AIRCRAFT TYPE’: ‘B’,
‘AVAILABLE WEIGHT ON AIRCRAFT’: 8995,
‘AVAILABLE VOLUME ON AIRCRAFT’: 3949,
‘SHIPMENT NUMBER’ : 1, ----- this is shipment id
‘SHIPMENT REVENUE’ :4,
‘ACTUAL RATE’: 66.23,
‘TOT-CHARGE ’: 6629.78
‘FLIGHT STATUS’: SCHEDULED,
‘COST’: 4884}
{‘FLIGHT ID’: ‘UW226’,
‘DEP’: ‘BOM’,
‘ARR’: ‘BLR’,
‘DEPARTURE DATE TIME’: ‘2022-10-23 05:04:04’,
‘ARRIVAL DATE TIME’: ‘2022-10-21 19:01:53’,
‘FLIGHT DURATION’: 8617,
‘MILAGE’: 162,
‘AIRCRAFT TYPE’: ‘B’,
‘AVAILABLE WEIGHT ON AIRCRAFT’: 8995,
‘AVAILABLE VOLUME ON AIRCRAFT’: 3949,
‘SHIPMENT NUMBER’ : 1, ----- this is shipment id
‘SHIPMENT REVENUE’ :4,
‘ACTUAL RATE’: 66.23,
‘TOT-CHARGE ’: 6629.78
‘FLIGHT STATUS’: SCHEDULED,
‘COST’: 4884}

FIG. 2 illustrates an example flow diagram of a logistics optimization process using a hybrid solver, such as hybrid solver 112 to invoke a classical computing device or a quantum computing device to solve for an optimal routing solution to a logistics optimization problem. This is intended to illustrate one example of the technology among others that will be described or recognized. In this example, the logistics optimization process includes data transformation, segmentation, parameterized path, solution distillation, solution validation, data inverse, classical threshold, and route processes. Processes of FIG. 2 may be performed using components or function of FIG. 1.

In this example, data transformation may be performed using graph generator 114 and comprises converting relational data tables into graphs that include nodes and vertices. Nodes may be treated as origins and destinations associated with routes and vertices may represent additional parameters such as distance, time, cost, mileage, weight, volume, etc.

Continuing with the example of FIG. 2, segmentation can be performed by route segmentor 116 and comprises segmentation mapping. Route segments are extracted from graph nodes based on origin and destination criteria with inclusion of feasible connectivity in terms of time of arrival and departure.

The parameterized path process comprises parameterized-path minimization, which may be performed using parametrized path determiner 118. For a given input requesting origin and destination, a shortest parametrized path is found among the graph nodes. In this example, parametrized path refers to routes that are weighted over a range of parameters such as distance, mileage, time, cost, weight, and volume etc. These parameters are typically governed by constraint equations associated with an underlying objective function, shown below:

$$= min {\sum }_{i , j}^{n} {R}_{ij} \cdot {F}_{ij} ( c , d , w , v , p )$$

[symbol] =optimal routes
c=cost
d=distance
w=weight
V=volume
P=package or other params
i,j=origin & destination

Solution distillation may be performed using filter 120 and comprises filtering the optimal routing solution and subsequently capturing it from a range of input parameters that respect the solution constraints as well as the objective function. Filter 120 may use the following to filter the shortest parameterized path:

[symbol]

[symbol]

[symbol]

{ [symbol] (c, d, w, v, p, . . . )}

Solution validation may be performed by solution validator 122 and comprises verifying that the solution is functionally and mathematically accurate enough. An automated solution validation methodology is employed to determine that the final solution is feasible and acceptable.

Data inverse comprises data inverse transformation, which may be performed by solution transformer 124. Now that the final solution is achieved in the computational domain, the solution is inverse transformed to map with the input request and create a consumable output that may provide insightful and feasible solutions to the end user.

The classical threshold process comprises applying a classical threshold to compute solution feasibility of the classical solver, which may be performed using hybrid solver determiner 126. The threshold enables a determination whether the classical solver is capable enough to deliver significant solutions.

The example process further comprises determining a route as an optimal solution using a classical computing solver by a classical computing device or a quantum computing solver by a quantum computing device based on the application of the threshold. Classical/quantum invoker 128 may facilitate determining the optimal solution by invoking a classical computing device, such as server 102, or a quantum computing device, such as quantum annealer 108.

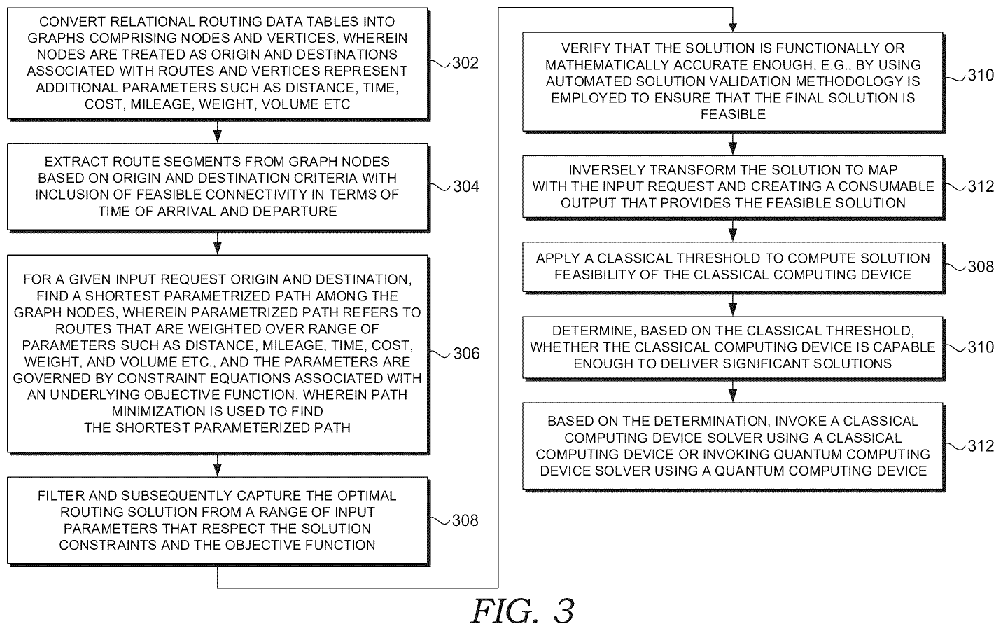

FIG. 3 is provided to illustrate an example method for using a hybrid solver to invoke a classical computing device or a quantum computing device for solving an optimization problem. Method 300 may be performed using components of FIG. 1.

In block 302, method 300 converts relational routing data tables into graphs comprising nodes and vertices, wherein nodes are treated as origins and destinations associated with routes, and vertices represent additional parameters such as distance, time, cost, mileage, weight, volume, and so forth.

In block 304, method 300 extracts route segments from graph nodes based on origin and destination criteria with inclusion of feasible connectivity in terms of time of arrival and departure.

In block 306, method 300, for a given input requests origin and destination, finds a shortest parametrized path among the graph nodes, wherein parametrized path refers to routes that are weighted over range of parameters such as distance, mileage, time, cost, weight, and volume, and the like, and the parameters are governed by constraint equations associated with an underlying objective function, wherein path minimization is used to find the shortest parameterized path.

In block 308, method 300 filters and subsequently captures the optimal routing solution from a range of input parameters that respect the solution constraints and the objective function.

In block 310, method 300 verifies that the solution is functionally or mathematically accurate enough, e.g., by using automated solution validation methodology to ensure that the final solution is feasible.

In block 312, method 300 inversely transforms the solution to map with the input request and creates a consumable output that provides the feasible solution. Route segments can be mapped based on a time of arrival or time of departure constraint. An example of the consumable output, in one aspect, is provided below:

```
Input: Single Shipment Request
(‘origin’: ‘DEL’, ‘destination’: ‘MAA’, ‘pickupdate’: ‘31DEC23’, ‘deliverydate’: ‘01JAN24’, ‘pickuptime’: 500,
‘deliverytime’: 2300, ‘packages’: 100, ‘volume’: 50.1, ‘weight’: 10000.2]
Output: Flights with 2 legs with minimum duration
{‘ROUTE1’:
      {‘LEG1’: (‘SEQ-NO’: ‘5’, ‘FLIGHT ID’: ‘UW1023’, ‘DEP’: ‘DEL’, ‘ARR’: ‘BOM’, ‘DEP DATE’: ‘2024-01-01’,
            ‘DEP TIME’: ‘205’, ‘ARRIVAL DATE’; ‘2024-01-01’, ‘ARR TIME’; ‘900’, ‘FLIGHT DURATION’; ‘115’,
            ‘MILAGE’: ‘706’, ‘AIRCRAFT TYPE’: ‘320’, ‘AVAILABLE WEIGHT ON AIRCRAFT’: 12000.0, ‘AVAILABLE
            VOLUME ON AIRCRAFT’: 70.0, ‘ACTUAL RATE’: ‘33.10’, ‘TOT-CHARGE’: ‘3310.00’, ‘FLIGHT DERATURE
            STATUS’: ‘SCHEDULED’, ‘FLIGHT ARRIVAL STATUS’: ‘SCHEDULED’,‘COST’: ‘9.78’},
      ‘LEG2’: (‘SEQ-NO’: ‘4’, ‘FLIGHT ID’: ‘UW226’, ‘DEP’: ‘BOM’, ‘ARR’: ‘MAA’, ‘DEP DATE’: ‘2024-01-01’,
            ‘DEP TIME’: ‘1315’, ‘ARRIVAL DATE’; ‘2024-01-01’, ‘ARR TIME’; ‘1615’, ‘FLIGHT DURATION’:
            ‘180’, ‘MILAGE’: ‘641’, ‘AIRCRAFT TYPE’: ‘777’, ‘AVAILABLE WEIGHT ON AIRCRAFT’: 4000.0,
            ‘AVAILABLE VOLUME ON AIRCRAFT’: 92.5, ‘ACTUAL RATE’: ‘25.85’, ‘TOT-CHARGE’: ‘2585.00’,
            ‘FLIGHT DERATURE STATUS’: ‘SCHEDULED’, ‘FLIGHT ARRIVAL STATUS’: ‘SCHEDULED’,‘COST’: ‘9.78’)},
‘ROUTE2’:
      {‘LEG1’: (‘SEQ-NO’: ‘5’, ‘FLIGHT ID’: ‘UW1023’, ‘DEP’: ‘DEL’, ‘ARR’: ‘BOM’, ‘DEP DATE’: ‘2024-01-01’,
            ‘DEP TIME’: ‘205’, ‘ARRIVAL DATE’; ‘2024-01-01’, ‘ARR TIME’; ‘900’, ‘FLIGHT DURATION’; ‘115’,
            ‘MILAGE’: ‘706’, ‘AIRCRAFT TYPE’: ‘320’, ‘AVAILABLE WEIGHT ON AIRCRAFT’: 12000.0, ‘AVAILABLE
            VOLUME ON AIRCRAFT’: 70.0, ‘ACTUAL RATE’: ‘33.10’, ‘TOT-CHARGE’: ‘3310.00’, ‘FLIGHT DERATURE
            STATUS’: ‘SCHEDULED’, ‘FLIGHT ARRIVAL STATUS’: ‘SCHEDULED’,‘COST’: ‘9.78’},
      ‘LEG2’: (‘SEQ-NO’: ‘5’, ‘FLIGHT ID’: ‘UW225’, ‘DEP’: ‘BOM’, ‘ARR’: ‘MAA’, ‘DEP DATE’: ‘2024-01-01’,
            ‘DEP TIME’: ‘1330’, ‘ARRIVAL DATE’; ‘2024-01-01’, ‘ARR TIME’; ‘1630’, ‘FLIGHT DURATION’; ‘180’,
            ‘MILAGE’: ‘641’, ‘AIRCRAFT TYPE’: ‘787’, ‘AVAILABLE WEIGHT ON AIRCRAFT’: 123000.0, ‘AVAILABLE
            VOLUME ON AIRCRAFT’: 122.0, ‘ACTUAL RATE’: ‘25.85’, ‘TOT-CHARGE’: ‘2585.00’, ‘FLIGHT DERATURE
            STATUS’: ‘SCHEDULED’, ‘FLIGHT ARRIVAL STATUS’: ‘SCHEDULED’,‘COST’: ‘9.78’)},
```

In block 314, method 300 applies a classical threshold to compute solution feasibility of the classical computing device.

In block 316, method 300 determines, based on the classical threshold, whether the classical computing device is capable enough to deliver significant solutions.

In block 318, method 300, based on the determination, invokes a classical computing device solver using a classical computing device or invokes a quantum computing device solver using a quantum computing device.

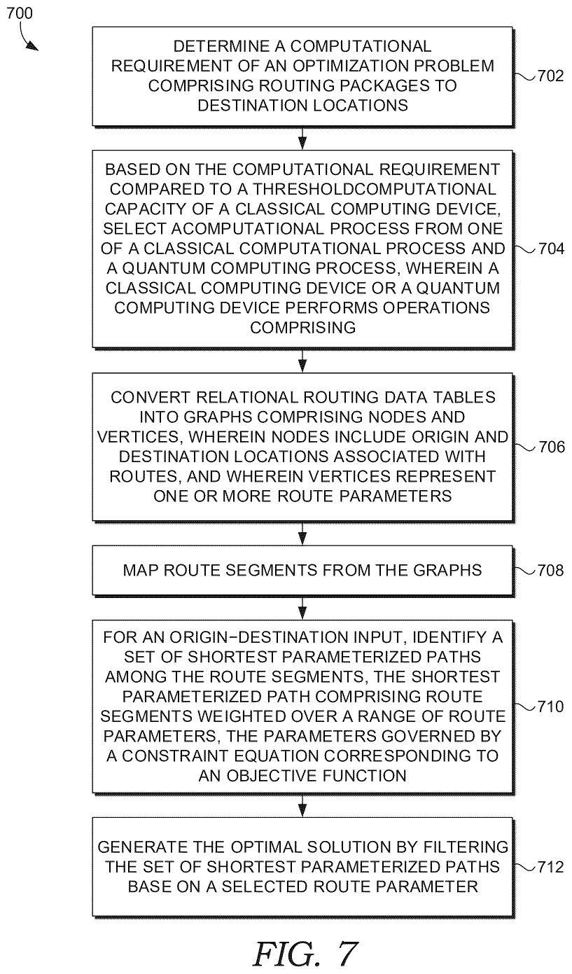

FIG. 7 is provided to illustrate an example method for using a hybrid solver to invoke a classical computing device or a quantum computing device for solving an optimization problem. Method 700 may be performed using components of FIG. 1.

In block 702, method 700 determines a computational requirement of an optimization problem comprising routing packages to destination locations.

In block 704, method 700 based on the computational requirement compared to a threshold computational capacity of a classical computing device, selects a computational process from one of a classical computational process and a quantum computing process, wherein a classical computing device or a quantum computing device performs operations comprising.

In block 706, method 700 converts relational routing data tables into graphs comprising nodes and vertices, wherein nodes include origin and destination locations associated with routes, and wherein vertices represent one or more route parameters.

In block 708, method 700 maps route segments from the graphs.

In block 710, method 700 for an origin-destination input, identifies a set of shortest parameterized paths among the route segments, the shortest parameterized path comprising route segments weighted over a range of route parameters, the parameters governed by a constraint equation corresponding to an objective function.

In block 712, method 700 generates the optimal solution by filtering the set of shortest parameterized paths base on a selected route parameter.

Each block of method 300 or method 700 may comprise a computing process performed using any combination of hardware, firmware, or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few possibilities. Method 300 and method 700 may be implemented in whole or in part by components of operating environment 100.

In aspects of the technology, the hybrid combination of the shortest parameterized path determination in combination with the filtering techniques described herein, provide models that significantly reduced the computational requirements of a computing device, such as a quantum computing device, thereby allowing the device to solve problems or explore a solution space that it otherwise would not be able to.

As such, a series of shortest parameterized paths can be determined in order to identify an optimal route. This may be determined based on the mapping methods previously described. However, it will be appreciated that there can be a large number of shortest parametrized paths. That is because there can be a large number of parameters, thus creating many parameterized paths between locations making up the solution space. These can be selected using filtering methods that can filter out the optimal route from the various shortest parameterized path based on a weighted parameter. That is, the filter can filter the shortest parameterized paths based on one or more parameter weights, e.g., which parameter is selected as important relative to other parameters. For example, one could select a filter for minimizing time and maximizing review, or minimizing carbon dioxide output, or arriving on a particular date, or any number or combination of parameters. Using the equations provided with respect to parametrized path determiner 118 and filter 120, the shortest parameterized paths can be determined and filtered based on a weighted set of parameters. This identifies a candidate optimal solution that can be validated and transformed as previously described, and then output as the optimal solution. In aspects, a computational threshold is applied to determine whether to solve for the optimal solution using a classical computing device or a quantum computing device.

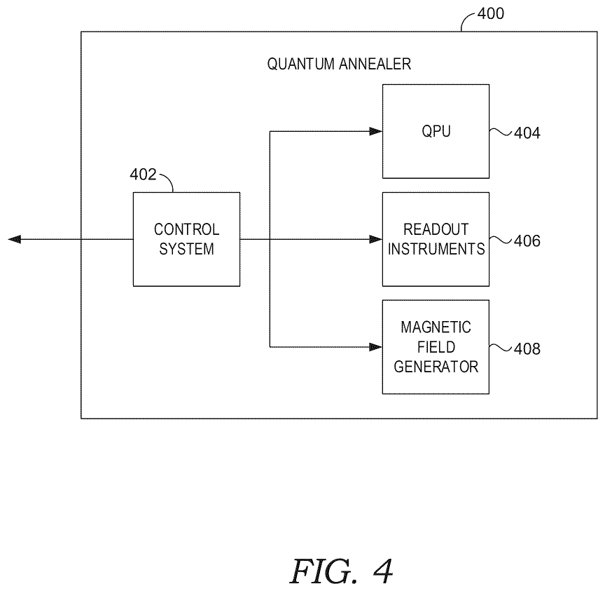

FIG. 4 illustrates an example quantum annealer 400 that may be employed with aspects of the technology. As FIG. 4 is only one example, other quantum annealers may be employed. Some examples of which may include D-Wave Systems annealers, which employ superconducting qubits to find the optimal or near-optimal ground state solutions to solving proposed optimization problems. As such, other quantum annealers having more of fewer components, and having different arrangements or architectures, may be used. It is again noted, that the illustrated quantum annealer 400 in FIG. 4 is only an example and is provided to aid in the description of the technology. It is not intended to limit the technology to one type of quantum annealer, or any type of quantum computing system. In the example provided, quantum annealer 400 comprises control system 402 operationally coupled to QPU 404, readout instruments 406, and magnetic field generator 408.

Control system 402 of quantum annealer 400 generally interfaces with components of quantum annealer 400, including QPU 404, readout instruments 406, and magnetic field generator 408, among other components not illustrated. For instance, control system 402 may operationally control or receive information from such components. Control system 402 facilitates quantum annealing functions, for example, translating a quantum problem into physical aspects of the QPU 404; setting parameters of the quantum annealing process, including the biases and couplings among qubits; managing the annealing schedule, a predefined protocol guiding the system from the initial to the final Hamiltonian that finds the global minimum representing the quantum problem's solution; among other functions and operations.

During the annealing process, control system 402 generates and delivers signals to the qubits and couplers of QPU 404, manipulating their states and interactions in accordance with the quantum problem being executed. In aspects, as the annealing process concludes, control system 402 may oversee the readout of qubits' states in coordination with readout instruments 406, thus translating quantum information into classical data that can be interpreted by classical computing devices.

Control system 402 may provide an interface for external systems by communicatively coupling with classical computing devices, such as computing device 1000 of FIG. 6, to facilitate the input of problem definitions and the output of solutions. Control system 402 itself may comprise a classical computer processor that reads from memory to execute computer-readable instructions stored thereon.

QPU 404 (i.e., a Quantum Processing Unit is the core of quantum computational activity. QPUs may house an array of qubits (quantum bits), which may exist in a superposition of states. QPU 404 facilitates quantum operations that exploit quantum phenomena like superposition and entanglement to solve quantum problems. Within QPU 404, couplers manage interactions between the qubits and form the basis for quantum logic gates and multi-qubit operations for quantum algorithms. Although not illustrated, QPU 404 may be cooled by a cooling device of quantum annealer 400 and shielded from other external components or interferences, helping to maintain quantum coherence.

QPU 404 may comprise control lines, across which signals are transmitted that guide quantum operations of QPU 404. QPU 404 may couple to readout instruments 406 to translate quantum states into classical data and communicate control system 402. Readout instruments 406 may include analog-to-digital converter that translates the quantum state of the qubits to the digital space, thereby identifying the quantum state of the qubits in manner readable by a classical machine, thus providing a candidate solution for the quantum problem to control system 402. In aspects, analog signals captured from qubit measurements may be amplified and filtered to sift through and eliminate noise.

Qubit states may be manipulated by control system 402 employing magnetic field generator 408. By varying the strength and orientation of the magnetic field, control system 402 can tailor the energy landscape that the qubits navigate during the annealing process. This magnetic field induces a bias on each qubit, influencing its tendency to take on a particular state during the annealing process.

The construction of quantum computers can be approached through various paradigms and hardware setups, among which gate-based quantum computing and adiabatic quantum computation (AQC) are predominant. Gate-based computing involves executing computations by applying a series of unitary gates to quantum bits (qubits), which are then measured at the computation's conclusion. Conversely, AQC starts with a many-qubit quantum state prepared as a simple Hamiltonian's ground state, which, through adiabatic time evolution, transitions to a final Hamiltonian, encoding the solution to a targeted optimization problem. AQC and gate-based quantum computing are polynomially equivalent since quantum circuits can be depicted as a time-dependent Hamiltonian with a maximal polynomial overhead.

Quantum annealing (QA) is closely related to AQC. QA is a variant of the AQC model, employed when adiabatic conditions are unfulfilled, leading to a heuristic variational quantum algorithm. This technique is adept at identifying the ground state of Ising models, an NP-hard challenge. NP-hard and NP-complete combinatorial optimization problems can be transformed to forms suitable for quantum annealers, either framed in Ising form or as a Quadratic Unconstrained Binary Optimization (QUBO) problem. For instance, these optimization problems can be transformed to Ising form using a {−1, 1} basis and spin variables or as a QUBO problem using the {0, 1} basis and binary variables. In QA, solving an optimization problem entails progressing through multiple stages, with the specifics of each stage being influenced by the kind of qubits utilized, the adiabatic protocol implemented, and other engineering factors.

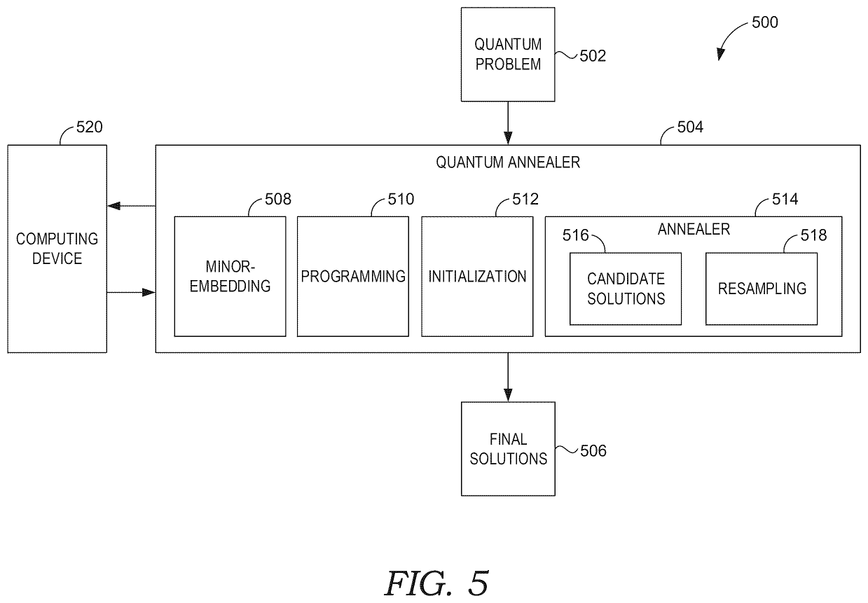

FIG. 5 illustrates an example quantum annealing process 500 utilizing quantum annealer 504. FIG. 5 is only one example provided as an aid for understanding and using the technology described herein. At a high level, quantum annealer 504 receives an input, illustrated using example quantum problem 502 and outputs candidate final solution(s) 506. Quantum annealing process 500 illustrates processes 508-518 that may be performed by or for quantum annealer 504 to determine final solution(s) 506. For instance, some aspects may be performed by a classical computing device 520 communicatively coupled quantum annealer 504. As an example, the classical computing device 520 may be used to facilitate aspects of minor-embedding process 508, programming process 510, initialization process 512 in coordination with quantum annealer 504. Computing device 1000 of FIG. 6 is an example suitable for use as computing device 520. Computing device 520 may interface with a control system of quantum annealer 504, which may be the same or separate computing devices. As with other aspects of FIG. 5, each of the processes is intended to represent an example, and nothing is intended to restrict the technology to a particular process or machine.

Having this in mind, quantum problem 502 may include optimization problems in various forms, such as QUBO model and an Ising model. Real-world problems can be broken down into objectives and constraints. Optimization problems can be represented by the following QUBO form:

$$min ( {\sum }_{i} {a}_{i} {x}_{i} + {\sum }_{i} {\sum }_{j > i} {b}_{i , j} {x}_{i} {x}_{j} + c )$$

The binary variables xᵢ and xⱼ may take values from {0, 1}, and aᵢ, bᵢ, and c are constraints defined by the problem to be solved.

Optimization problems may be expressed by the Ising model, taking the following form:

$$min ( {\sum }_{i} {h}_{i} {s}_{i} + {\sum }_{i} {\sum }_{j > i} {J}_{i , j} {s}_{i} {s}_{j} )$$

The binary variables sᵢ and sⱼ may take values from {−1, 1}, whereas J_{i,j} is the interaction of two adjacent sites <i,j> for a given magnetic field hi. The QUBO form and the Ising form may be translated from one another in some cases.

The models may be represented by a logical graph. For a QUBO problem, each node may correspond to a variable which may correspond to qubits. Edges in this graph represent the interaction terms between pairs of variables, derived from the quadratic terms in the QUBO expression. Similarly, for an Ising model, each node may represent a spin and correspond to qubits. Edges may denote the interactions between pairs of spins (or variables) as dictated by the interaction terms in the Ising model's energy expression. Such models may be formulated or represented as logical graph and provided as a quantum problem 502 to quantum annealer 504.

During minor-embedding process 508 the local graph of the initial quantum problem 502 may be translated onto the physical hardware of the quantum processing unit (QPU). Here, select sets of physical qubits represent the nodes, while couplings between the qubits correspond to the interaction of the logical variables.

During programming process 510 the quantum annealer 504 may be programmed with the parameters that define the problem. This problem may be the final Hamiltoninan. The final Hamiltonian is a quantum mechanical operator that represents the problem to be solved in a form that quantum annealer 504 understands. It is derived from the logical representation of the problem (such as the QUBO formulation or the Ising model). The objective is to find the state (or configuration of qubits) that minimizes its energy as this corresponds to the solution of quantum problem 502.

The programming process 510 may comprise setting weights for each qubit bias and coupler strength. Qubits in quantum annealer 504 can have a bias, for example a term in the final Hamiltonian that represents an external magnetic field acting on the qubit. Setting the bias on a qubit influences its tendency to take a particular state (0 or 1). Weights for the qubit bias may be set based on the problem formulation to guide quantum annealer 504 toward the desired solution. Couplers may comprise elements in quantum annealer 504 that control the interaction between pairs of qubits. The strength of a coupler determines the extent to which the state of one qubit influences the state of another. Coupler strength may be set to represent the interactions between variables in quantum problem 502.

During initialization process 512, an initial Hamiltonian may be defined. The initial Hamiltonian may be constructed to have an achievable lowest energy (ground state) configuration. The design may serve as a starting point for the annealing process 514.

Through annealing process 514, quantum annealer 504 gradually transitions from the initial Hamiltonian to the final Hamiltonian (which was defined during the programming phase and represents the actual problem to be solved). Generally, as the system transitions, quantum annealer 504 attempts to maintain the lowest-energy configuration, and ideally end in the ground state of the final Hamiltonian, which corresponds to the solution of the quantum problem 502. In some cases, annealing process 514 can also be combined with a reverse annealing phase, which initializes quantum annealer 504 with a known (classical) solution and searches the state space around this local optimum.

At the end of annealing process 514, quantum annealer 504 provides candidate solutions 516 to quantum problem 502. Here, the qubits in the QPU are in an eigenstate or a superposition of eigenstates with respect to the final Hamiltonian. An eigenstate refers to a state with a well-defined energy and represents a possible solution. A superposition of eigenstates refers to multiple eigenstates at once, each representing a potential solution to the problem. Each qubit's spin (either up or down) is read out, and the collection of spin values represents a candidate solution to quantum problem 502.

Quantum annealing is heuristic and the exact optimal solution (ground state of the final Hamiltonian) may not be found in every run. Instead, the candidate solutions 516 provide a good enough solution in a reasonable amount of time. Naturally, there's a non-zero probability of ending up in a non-optimal solution due to various quantum phenomena like tunneling and thermal fluctuations. As such annealing process 514 may undergo resampling 518, which repeats the annealing process 514 in an effort to identify a better solution that prior candidate solutions 516. Each resampling process provides a new opportunity for the quantum annealer 504 to explore the solution space and possibly find a better or different candidate solution. Resampling 518 may be performed as many times as desired, as time and continued benefit allow. By comparing candidate solutions 516, the best candidate solution or even a variety of candidate solutions may be chosen as solutions to quantum problem 502 and output as final solution(s) 506.

Having described an overview of some embodiments of the present technology, an example computing environment in which embodiments of the present technology may be implemented is described below in order to provide a general context for various aspects of the present technology. Referring now to FIG. 6 in particular, an example operating environment for implementing embodiments of the present technology is shown and designated generally as computing device 1000. Computing device 1000 is but one example of a suitable computing environment and is not intended to suggest any limitation as to the scope of use or functionality of the technology. Computing device 1000 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant or other handheld device. Generally, program modules, including routines, programs, objects, components, data structures, etc., refer to code that performs particular tasks or implements particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 6, computing device 1000 includes bus 1002, which directly or indirectly couples the following devices: memory 1004, one or more processors 1006, one or more presentation components 1008, input/output (I/O) ports 1010, input/output components 1012, and illustrative power supply 1014. Bus 1002 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 6 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 6 and with reference to “computing device.”

Computing device 1000 typically includes a variety of computer-readable media. Computer-readable media can be any available media that can be accessed by computing device 1000 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1000. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1004 includes computer-storage media in the form of volatile or non-volatile memory. The memory may be removable, non-removable, or a combination thereof. Example hardware devices include solid-state memory, hard drives, optical-disc drives, etc. Computing device 1000 includes one or more processors that read data from various entities, such as memory 1004 or I/O components 1012. Presentation component(s) 1008 presents data indications to a user or other device. Example presentation components include a display device, speaker, printing component, vibrating component, etc.

I/O ports 1010 allow computing device 1000 to be logically coupled to other devices, including I/O components 1012, some of which may be built in. Illustrative components include a microphone, joystick, game pad, satellite dish, scanner, printer, wireless device, etc. The I/O components 1012 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1000. Computing device 1000 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1000 may be equipped with accelerometers or gyroscopes that enable detection of motion. The output of the accelerometers or gyroscopes may be provided to the display of computing device 1000 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, functional components of FIG. 1 can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to 112, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of hybrid solver 112, among other functions, may be performed by server 102, computing device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving,” or “transmitting,” as facilitated by software or hardware-based buses, receivers, or transmitters” using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “computing device” is intended to refer to a classical computing device, such as computing device 1000 of FIG. 6. Other related terms, including “client device,” “server,” and the like are similarly intended to refer to a classical computing device. Terms that include “quantum” are intended to refer to a quantum computing device, such as a quantum annealer. An example quantum computing device is illustrated and described with respect to FIG. 4.

An optimal solution (also referred to as optimal route), as described herein is intended to be the most favorable solution derived from a set of potential solutions generated within the constraints of available processing power and time. This solution minimizes or maximizes the defined objective(s) based on the data and algorithms employed during the computational process, such as the annealing process. It represents the best solution among those explored, within the computational resources allocated, to solve the optimization problem and achieve the desired logistical outcome. While it may not represent the absolute best solution possible due to limitations in computational resources, data accuracy, or physical interferences, it stands as the most efficient or effective solution identified through the computational process undertaken for a given set of parameters.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some aspects of the technology that may be practiced from the foregoing description include, but are not limited to, the following:

Aspect 1: A computerized method comprising: converting relational routing data tables into graphs comprising nodes and vertices, wherein nodes include origins and destinations associated with routes, and wherein vertices represent one or more route parameters; mapping route segments from the graphs; for an origin-destination input, identifying a shortest parameterized path among the route segments, the shortest parameterized path comprising route segments weighted over a range of input parameters, the input parameters governed by a constraint equation corresponding to an objective function; determining a solution domain from the range of input parameters; and generating an optimal solution within the solution domain based on applying a classical threshold, wherein based on the classical threshold, the optimal solution is generated using a process selected from one of a classical computing process and a quantum solution process, wherein: the classical computing process invokes a classical computing device to determine the optimal solution from the solution domain; and the quantum computing process invokes a quantum annealer to determine the optimal solution from the solution domain.

Aspect 2: A system comprising: a classical computing device; a quantum annealer; at least one processor; and one or more computer storage media storing computer readable instructions thereon that when executed by the at least one processor cause the at least one processor to perform operations comprising: converting relational routing data tables into graphs comprising nodes and vertices, wherein nodes include origins and destinations associated with routes, and wherein vertices represent one or more route parameters; mapping route segments from the graphs; for an origin destination input, identifying a shortest parameterized path among the route segments, the shortest parameterized path comprising route segments weighted over a range of input parameters, the input parameters governed by a constraint equation corresponding to an objective function; determining a solution domain from the range of input parameters; and generating an optimal solution within the solution domain based on applying a classical threshold, wherein based on the classical threshold, the optimal solution is generated using a process selected from one of a classical computing process and a quantum solution process, wherein: the classical computing process invokes the classical computing device to determine the optimal solution from the solution domain; and the quantum computing process invokes the quantum annealer to determine the optimal solution from the solution domain.

Aspect 3: One or more computer storage media storing computer-readable instructions thereon that when executed by a processor cause the processor to perform operations comprising: determining a computational requirement of an optimization problem comprising routing packages to destination locations; and based on the computational requirement compared to a threshold computational capacity of a classical computing device, selecting a computational process from one of a classical computational process and a quantum computing process, wherein a classical computing device or a quantum computing device performs operations comprising: converting relational routing data tables into graphs comprising nodes and vertices, wherein nodes include origin and destination locations associated with routes, and wherein vertices represent one or more route parameters; mapping route segments from the graphs based on a time of arrival or time of departure constraint; for an origin-destination input, identifying a set of shortest parameterized paths among the route segments, the shortest parameterized path comprising route segments weighted over a range of input parameters, the input parameters governed by a constraint equation corresponding to an objective function; and generating the optimal solution by filtering the set of shortest parameterized paths based on a selected route parameter.

Aspect 4: Any of Aspects 1-3, wherein the one or more route parameters comprise at least one of distance, time, cost, weight, or volume.

Aspect 5: Any of Aspects 1-4, wherein route segments are mapped based on a time of arrival or time of departure constraint.

Aspect 6: Any of Aspects 1-5, wherein the input parameters is one of distance, time, cost, and object weight.

Aspect 7: Any of Aspects 1-6, further comprising minimizing the constraint equation to identify the shortest parameterized path.

Aspect 8: Any of Aspects 1-7, further comprising filtering the optimal routing solution from the range of input parameters such that the optimal routing solution respects solution constraints and the objective function.

Aspect 9: Any of Aspects 1-8, further comprising verifying an accuracy of the shortest parameterized path.

Aspect 10: Any of Aspects 1-9, further comprising inverse transforming the optimal routing solution to map the optimal routing solution to the origin-destination input to output the optimal routing solution to a computing device.

What is claimed is:

1. A computerized method comprising:
converting relational routing data tables into graphs comprising nodes and vertices, wherein nodes include origins and destinations associated with routes, and wherein vertices represent one or more route parameters;
mapping route segments from the graphs;
for an origin-destination input, identifying a shortest parameterized path among the route segments, the shortest parameterized path comprising route segments weighted over a range of input parameters, the input parameters governed by a constraint equation corresponding to an objective function;
determining a solution domain from the range of input parameters; and
generating an optimal solution within the solution domain based on applying a classical threshold, wherein based on the classical threshold, the optimal solution is generated using a process selected from one of a classical computing process and a quantum solution process, wherein:
the classical computing process invokes a classical computing device to determine the optimal solution from the solution domain; and
the quantum computing process invokes a quantum annealer to determine the optimal solution from the solution domain.

2. The method of claim 1, wherein the one or more route parameters comprise at least one of distance, time, cost, weight, or volume.

3. The method of claim 1, wherein route segments are mapped based on a time of arrival or time of departure constraint.

4. The method of claim 1, wherein the input parameters is one of distance, time, cost, and object weight.

5. The method of claim 1, further comprising minimizing the constraint equation to identify the shortest parameterized path.

6. The method of claim 1, further comprising filtering the optimal routing solution from the range of input parameters such that the optimal routing solution respects solution constraints and the objective function.

7. The method of claim 1, further comprising verifying an accuracy of the shortest parameterized path.

8. The method of claim 1, further comprising inverse transforming the optimal routing solution to map the optimal routing solution to the origin-destination input to output the optimal routing solution to a computing device.

9. A system comprising:
a classical computing device;
a quantum annealer;
at least one processor; and
one or more computer storage media storing computer readable instructions thereon that when executed by the at least one processor cause the at least one processor to perform operations comprising:
converting relational routing data tables into graphs comprising nodes and vertices, wherein nodes include origins and destinations associated with routes, and wherein vertices represent one or more route parameters;
mapping route segments from the graphs;
for an origin-destination input, identifying a shortest parameterized path among the route segments, the shortest parameterized path comprising route segments weighted over a range of input parameters, the input parameters governed by a constraint equation corresponding to an objective function;
determining a solution domain from the range of input parameters; and
generating an optimal solution within the solution domain based on applying a classical threshold, wherein based on the classical threshold, the optimal solution is generated using a process selected from one of a classical computing process and a quantum solution process, wherein:
the classical computing process invokes the classical computing device to determine the optimal solution from the solution domain; and
the quantum computing process invokes the quantum annealer to determine the optimal solution from the solution domain.

10. The system of claim 9, further comprising further comprising minimizing the constraint equation to identify the shortest parameterized path.

11. The system of claim 9, further comprising filtering the optimal routing solution from the range of input parameters such that the optimal routing solution respects solution constraints and the objective function.

12. The system of claim 9, further comprising verifying an accuracy of the shortest parameterized path.

13. The system of claim 9, further comprising inverse transforming the optimal routing solution to map the optimal routing solution to the origin-destination input to output the optimal routing solution to a computing device.

14. One or more computer storage media storing computer-readable instructions thereon that when executed by a processor cause the processor to perform operations comprising:
determining a computational requirement of an optimization problem comprising routing packages to destination locations; and
based on the computational requirement compared to a threshold computational capacity of a classical computing device, selecting a computational process from one of a classical computational process and a quantum computing process, wherein a classical computing device or a quantum computing device performs operations comprising:
converting relational routing data tables into graphs comprising nodes and vertices, wherein nodes include origin and destination locations associated with routes, and wherein vertices represent one or more route parameters;
mapping route segments from the graphs;
for an origin-destination input, identifying a set of shortest parameterized paths among the route segments, the shortest parameterized path comprising route segments weighted over a range of input parameters, the input parameters governed by a constraint equation corresponding to an objective function; and
generating the optimal solution by filtering the set of shortest parameterized paths based on a selected route parameter.

15. The media of claim 14, wherein the one or more route parameters comprise at least one of distance, time, cost, weight, or volume.

16. The media of claim 14, wherein the input parameters is one of distance, time, cost, and object weight.

17. The media of claim 14, further comprising minimizing the constraint equation to identify the shortest parameterized path.

18. The media of claim 14, further comprising filtering the optimal routing solution from the range of input parameters such that the optimal routing solution respects solution constraints and the objective function.

19. The media of claim 14, further comprising verifying an accuracy of the shortest parameterized path.

20. The media of claim 14, further comprising inverse transforming the optimal routing solution to map the optimal routing solution to the origin-destination input to output the optimal routing solution to a computing device.
